(19) United States
(12) Patent Application Publication
(10) Pub. No.: US 2025/0183341 A1
(43) Pub. Date: Jun. 5, 2025

(54) DECOUPLED ELECTRODE ELECTROCHEMICAL ENERGY STORAGE SYSTEM

(71) Applicant: FORM ENERGY, INC., Somerville, MA (US)

(72) Inventors: Danielle Cassidy SMITH, Cambridge, MA (US); William Henry WOODFORD, Cambridge, MA (US); Jarrod David MILSHTEIN, Arlington, MA (US); Annelise Christine THOMPSON, Medford, MA (US); Alexandra ROUSSEAU, Peterborough (CA); Jessa SILVER, Roxbury, MA (US)

(21) Appl. No.: 18/971,608

(22) Filed: Dec. 6, 2024

Related U.S. Application Data
(62) Division of application No. 17/313,819, filed on May 6, 2021.
(60) Provisional application No. 63/020,709, filed on May 6, 2020.

(51) Int. Cl. H01M 8/1027; H01M 4/52; H01M 8/14

(52) U.S. Cl. CPC H01M 8/1027; H01M 4/521; H01M 8/146

(57) ABSTRACT

Systems and methods of the various embodiments may provide decoupled electrode electrochemical energy storage systems.

### RELATED APPLICATIONS

This application is a divisional of U.S. patent application Ser. No. 17/31,819 filed May 6, 2021, entitled “Decoupled Electrode Electrochemical Energy Storage System,” which claims priority to U.S. Provisional Application No. 63/020,709 filed May 6, 2020 entitled “Decoupled Electrode Electrochemical Energy Storage System”, with entire contents of each of these applications hereby incorporated by reference herein.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, at least ≥8 h) energy storage systems.

Metal-air batteries are attractive options for electrochemical energy storage due to the low cost and abundance of air as a reagent for the energy storing reactions. Many challenges associated with the development of metal-air batteries are associated with the mechanical cell architecture. Certain architectures which are suitable for small-scale storage, such as are used for zinc-air hearing aid batteries, are not suitable for large scale energy storage, such as for grid-connected applications.

Iron-air batteries are useful for long duration storage because of the low cost of chemicals, which enables an entitlement to long duration at an economically viable cost structure. A static iron-air battery uses a fixed iron anode and operates with a direct, inverse, relationship between duration and current density, i.e. to achieve long duration, current density must be lowered. One of the challenges of this cell and system architecture is that the parasitic losses due to balance of plant subsystems (e.g., air delivery, water management, etc.) are often relatively fixed—i.e., there is some fixed parasitic loss almost independent of the current density. Thus, on a percentage basis, the losses are greater as current density is decreased. Therefore, it is advantageous to have a system which can achieve long duration and high current density.

In energy storage systems with a solid metal plus oxygen chemistry, the energy storage capacity scales with the amount of metal in the system. It is helpful to the system design to be able to decouple the energy storage capacity from the desired power capability, which is predominantly determined by elements other than the solid metal component.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems and methods of the various embodiments may provide decoupled electrode electrochemical energy storage systems. Various embodiments may provide an iron-air flow battery. Various embodiments may provide a metal/air energy storage system in which the metal is mobile. In various embodiments, the metal electrode may comprise direct reduced iron (DRI).

Various embodiments may provide a metal/air energy storage system, comprising: a metal electrode vessel, the metal electrode vessel comprising a bed of metal; at least one other electrode; and a pump configured to move electrolyte between the metal electrode vessel and the at least one other electrode

Various embodiments may provide an iron-air flow battery, comprising: a fully open reactor through which iron materials and air are flowed.

Various embodiments may provide a metal/air energy storage system, comprising: a metal flow passage; metal pellets; one or more air electrodes; and one or more separators configured to separate the metal flow passage from the one or more air electrodes, wherein the system is configured such that the metal pellets are flowed through the metal flow passage past the one or more air electrode

### BRIEF DESCRIPTION OF THE FIGURES

The accompanying drawings, which are incorporated herein and constitute part of this specification, illustrate example embodiments of the claims, and together with the general description given above and the detailed description given below, serve to explain the features of the claims.

FIG. 1 illustrates a decoupled electrode electrochemical energy storage system according to various embodiments.

FIG. 2A illustrates an oxygen reduction reaction (ORR) electrode according to various embodiments.

FIG. 2B illustrates an ORR electrode according to various embodiments.

FIG. 3 illustrates an ORR electrode according to various embodiments.

FIG. 4 illustrates oxygen evolution reaction (OER) electrode configurations according to various embodiments.

FIG. 5 illustrates an example ORR electrode assembly configuration according to various embodiments.

FIG. 6 illustrates an example OER electrode assembly configuration according to various embodiments.

FIG. 7 illustrates an electrochemical energy storage system according to various embodiments.

FIG. 8 illustrates an example configuration of an electrolyte vessel according to various embodiments.

FIG. 9 illustrates a simplified version of a decoupled electrode energy storage system according to various embodiments.

FIG. 10 illustrates a specific example of the system of FIG. 9.

FIG. 11 illustrates a metal/air energy storage system according to various embodiments.

FIG. 12 illustrates an alternative configuration for a metal/air energy storage system according to various embodiments.

FIG. 13 illustrates a metal/air energy storage system according to various embodiments.

FIG. 14 illustrates a metal/air energy storage system according to various embodiments.

FIGS. 15-23 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

In energy storage systems with a solid metal plus oxygen chemistry, the energy storage capacity scales with the amount of metal in the system. It is helpful to the system design to be able to decouple the energy storage capacity from the desired power capability, which is predominantly determined by elements other than the solid metal component.

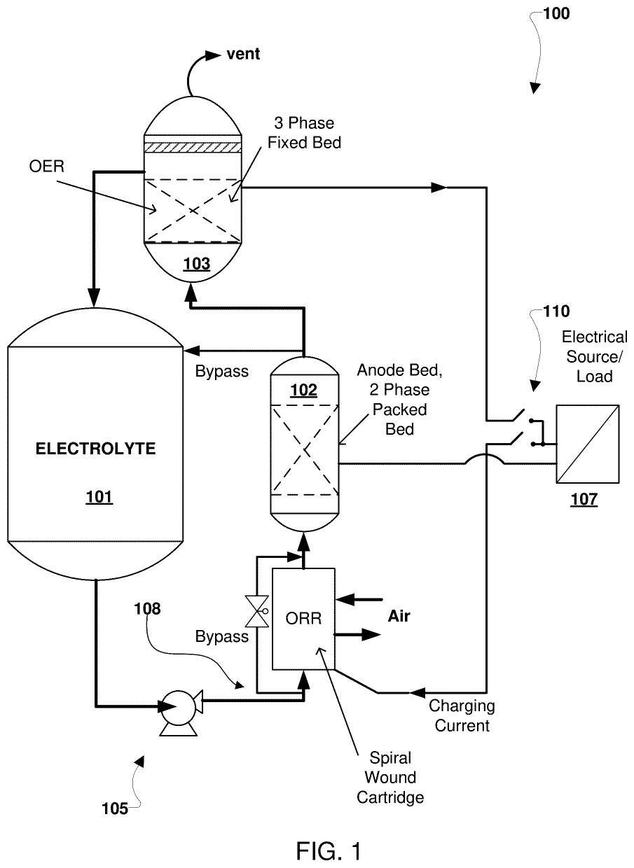

Performance advantages of these battery architecture configurations are shown in Table 1 and Table 2. Table 1 depicts possible performance attributes where the metal electrode and air electrodes are housed in separate vessels and the electrolyte is flowing through the vessels according to various embodiments (e.g., as illustrated and discussed with reference to FIGS. 1-10):

TABLE 1

| Reactor Property | Embodiment Range | |
|---|---|---|
| Anode Vessel Volume | 0.5-100 | m³ |
| Electrolyte Vessel Volume | 0.5-100 | m³ |
| Air Electrodes Current Density | 3-200 | mA/cm² |
| Superficial Electrolyte Velocity | 1-100 | cm/s |
| Auxiliary Power Load | 5-300 | kW/MW |
| Reactor Lifetime | 5-30 | years |
| Reactor Discharge Duration | 25-500 | hours |

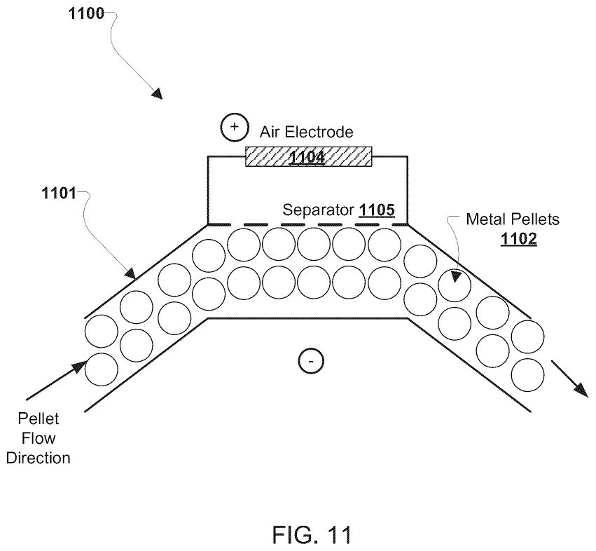

Table 2 depicts possible performance attributes where the air electrode(s) is stationary and the metal electrode is flowing through an electrochemical reactor in close proximity according to various embodiments (e.g., as illustrated and discussed with reference to FIGS. 11-14):

TABLE 2

| Reactor Property | Embodiment Range | |
|---|---|---|
| Air Electrodes Current Density | 3-200 | mA/cm² |
| Anode Metal Flow Rate | 0.1-10 | kg/s |
| Superficial Electrolyte Velocity | 1-100 | cm/s |
| Auxiliary Power Load | 5-300 | kW/MW |
| Reactor Lifetime | 5-30 | years |
| Reactor Discharge Duration | 25-500 | hours |

A reliance on electro-migration, diffusion, and other naturally motivated ion transport limits the scale and structure of individual electrodes by requiring the distance between them to be small. These design restrictions result in highly constrained cell architectures and smaller components with a higher piece counts for large capacity energy storage systems.

Removing the constraints of reliance on electro-migration, diffusion, and other and naturally motivated ion transport may provide five benefits. First, it may allow independent optimization of the various electrodes in terms of form, structure and performance. Second, it may allow the electrodes to be much larger in scale, reducing piece count and assembly/installation costs. Third, the energy storage capacity may be made independent from the power delivery capacity. Fourth, individual units may be easily swapped out for either identical replacement units, improved next generation units, or units with higher energy/power capacities. Fifth, ion transport via forced convection may overcome concentration polarization in the electrolyte and electrode materials, leading to energy storage devices with higher performance, namely higher power density, larger accessible capacity, and smaller overpotential losses.

In various embodiments, by motivating ion transport between electrodes by a motive force, such as a pump, the distance between electrodes can be increased while maintaining electrochemical performance. In a metal/air, three-electrode energy storage system, each electrode may be designed individually without interdependent conflicts/restrictions in various embodiments. FIGS. 1-10 illustrate aspects of decoupled electrode electrochemical energy storage systems according to various embodiments. FIG. 1 illustrates a decoupled electrode electrochemical energy storage system 100 according to various embodiments. The system 100 may include a metal electrode containment vessel 102 fluidically connected to an oxygen evolution reaction (OER) electrode containment vessel 103, electrolyte surge vessel 101, and an oxygen reduction reaction (ORR) electrode containment vessel 104. Electrolyte may be flowed to/from one or more of the metal electrode containment vessel 102, OER electrode containment vessel 103, electrolyte containment vessel 101, and ORR electrode containment vessel 104 by a pump 105. The system 100 may provide current to, and/or receive current from, an electrical source/load 107. An electrical switch 110 may provide the ability to electrically connect different combinations of electrodes. The system 100 may be a metal/air system in various embodiments.

In various embodiments, the metal electrode may be in any form that has a relatively high surface area to volume ratio with electric conductive continuity. Examples of forms that may have a relatively high surface area to volume ratio with electric conductive continuity include powder, pellets, spheroids, metal foam, etc. As a specific example, the metal may be iron pellets. The metal pellets may be direct reduced iron (DRI) pellets. In various embodiments, the metal may be DRI, whether in the form of powder, pellets, spheroids, or any other form. The metal electrode may be disposed within the metal electrode containment vessel 102. The metal electrode may be a porous electrode. In some embodiments, the metal electrode may be an iron electrode, such as a porous iron electrode. In various embodiments, an iron electrode may include DRI in one or more various forms, such as powder, pellets, spheroids, or any other form. In various embodiments, iron electrode may include packed iron powder and/or sintered iron powder. In various embodiments, the iron powder included in the iron electrode may be sponge iron powder and/or atomized iron powder. In various embodiments, the iron electrode may include an iron powder and a polymer binder, such as sponge iron powder and a polymer binder and/or atomized iron and a powder binder. In some embodiments, the iron electrode may be formed without carbon. In other words, the iron electrode may not include carbon added therein, such that the iron electrode does not include carbon. As specific examples, the iron electrode may include sponge iron powder and a polymer binder without carbon and/or atomized iron and a powder binder without carbon. In some embodiments, the iron electrode may include carbon. In other words, carbon may be an additive element selected to form at least a portion of the composition that is the iron electrode. As specific examples, the iron electrode may include sponge iron powder, a polymer binder, and carbon and/or the iron electrode may include atomized iron, a powder binder, and carbon.

In various embodiments, the metal may be loaded into a containment vessel, e.g., a packed bed. For example, the metal in the containment vessel may be supported by a permeable bed support structure which is itself supported off the vessel walls. The vessel may be vertical or horizontal. The vessel may have at least one liquid inlet and one liquid outlet. For ease of explanation, the metal electrode containment vessel 102 with the metal therein may be referred to as the metal electrode, the electrode vessel, or the metal electrode containment vessel 102. The metal electrode containment vessel 102 may be an anode of the system 100 and may be a two-phase packed bed in various embodiments. The various inlets and/or outlets to the metal electrode containment vessel 102 may be flow controlled inlets/outlets in various embodiments.

In various embodiments, electrolyte may be provided into the metal electrode containment vessel 102 (e.g., pumped in, gravity flowed in, or otherwise fluidically provided to the electrode vessel). The electrolyte may flow into the metal electrode containment vessel 102 via at least one liquid inlet to the electrode vessel 102. The electrolyte may be stored in an electrolyte vessel 101 that may store a volume of electrolyte. The electrolyte vessel 101 may have one or more inlet to allow electrolyte into the electrolyte vessel 101 and/or may have one or more outlet to allow electrolyte out of the electrolyte vessel 100. The various inlets and/or outlets to the electrolyte vessel 101 may be valve controlled inlets/outlets in various embodiments. The electrolyte may flow through the packed bed (e.g., the packed bed of metal in the electrode vessel 102) and out of the electrode vessel 102 via at least one liquid outlet. The electrolyte flow may be driven by the pump 105 connected to an electrolyte circulation piping system, such as an electrolyte circulation piping system illustrated in FIG. 1 that fluidically connects the electrode vessel 102, OER electrode 103, electrolyte vessel 101, and ORR electrode 104. The electrolyte piping system may include one or more bypass conduits and/or bypass valves to change the routing and flow of electrolyte in the system 100, including to isolate one or more of the electrode vessel 102, OER electrode 103, electrolyte vessel 101, and/or ORR electrode 104 from one another. While illustrated as a single pump 105 in FIG. 1, the number and placement of the pump 105 is merely an example, and one or more additional pumps may be included in the system 100 and/or the placement of the pump 105 may be at different points in the electrolyte circulation piping system in various embodiments. The electrode vessel 102 may be maintained with a volume of electrolyte therein by the pump 105 and electrolyte circulation piping system. As an example, the electrode vessel 102 may be maintained full of liquid electrolyte.

In various embodiments, physically separating the electrode vessel 102 and OER electrode 103 may reduce the impact of oxygen bubbles or dissolved oxygen on the performance and durability of the metal electrode. In certain embodiments, physically separating the electrode vessel 102 and OER electrode 103 may reduce the rate of self-discharge of the metal electrode by mitigating contact of oxygen bubbles or dissolved oxygen gas with the metal bed. In some embodiments, physically separating the electrode vessel 102 and OER electrode 103 may reduce the rate of oxidation of sulfur-containing additives (e.g., lithium sulfide, sodium sulfide, potassium sulfide, bismuth sulfide, iron sulfide), thereby improving metal electrode capacity over the lifetime of the device. In various embodiments, separating the OER electrode 103 from the other components of the electrochemical system may enable more facile collection and storage of the oxygen generated at the OER electrode.

In various embodiments, current is collected from within the metal bed via the metal itself. In various embodiments, there may also be dedicated structures, vertical or horizontal, within the bed to assist with current collection. In various embodiments, the current may be collected off the electrode vessel 102 itself. In various embodiments, the electrode vessel 102 may be constructed of an electrically conductive material and therefore enable the current collection itself. In various embodiments, the electrode vessel 102 may be constructed of a non-electrically conductive or insulating material and therefore not participate in the circuit. In various embodiments, current may be collected and provided to the electrical source/load 107 via one or more electrical buses connected to the electrical source/load 107. The electrical bus may include one or more switches 110 to reroute current to/from the electrical source/load 107.

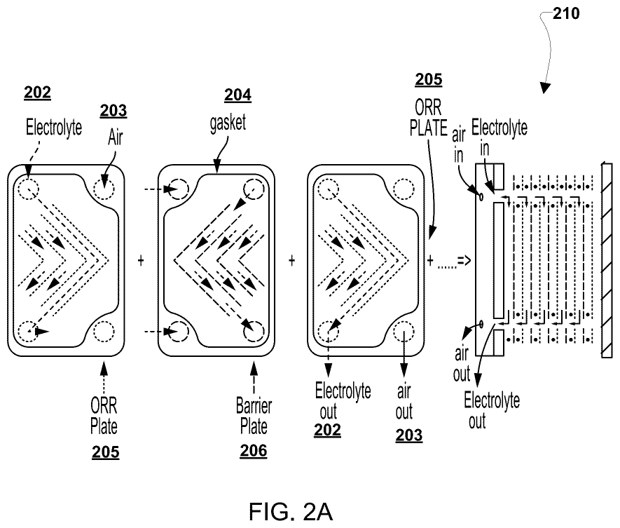

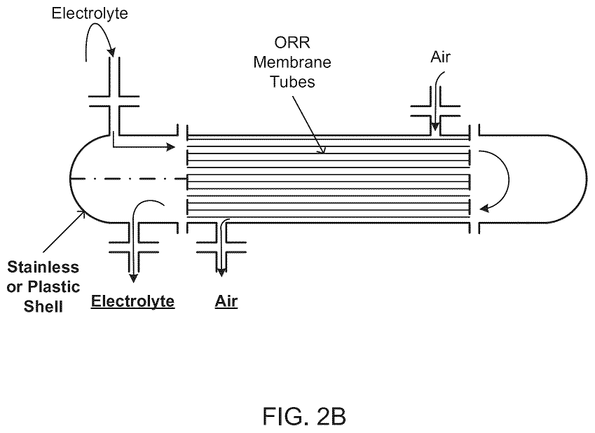

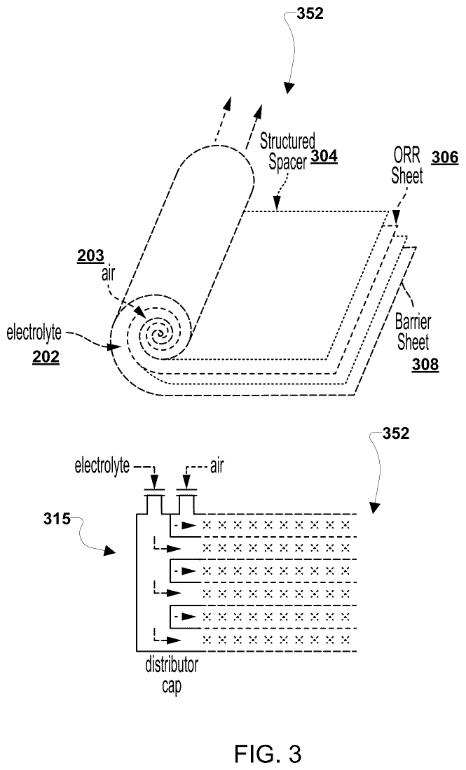

In various embodiments, the ORR electrode 104 may be in any one or more of a variety of familiar three phase forms which maximize active solid surface area contact with the liquid on one side and air/oxygen on the other side. FIGS. 2A, 2B, and 3 illustrate example forms of the ORR electrode 104.

As illustrated in FIG. 2A, in various embodiments, the ORR electrode 104 may be in the form of a plate and frame structure 210, in which one fluid is electrolyte 202, and the other fluid is air 203. The plate and frame structure 210 may also be referred to as an electrochemical stack design. The plates in the structure 210 may alternate with ORR plates 205 formed from ORR materials and barrier plates 206. The ORR plates 205 may be replaced with the oxygen reducing membrane with integral support structure and current collection. A gasket 204 may be disposed between each of the plates 205 and 206 to prevent fluid from leaking out of the unit. Two rigid plates 207 may be bolted on either side of the plate stack, applying a compressive load.

In various embodiments, the ORR electrode 104 may be in the form of a shell and tube structure, similar to a shell and tube heat exchanger, in which oxygen reducing membrane tubes are formed with an integral support structure and current collector. The air 203 would flow through the unit either on the shell side or the tube side, while the electrolyte 202 would flow through the other side, either the shell or the tube side. Configuring the unit with the electrolyte on the tube side has the benefit of high electrolyte velocities, which may reduce fouling associated with the electrolyte. As illustrated in FIG. 2B, the tubes may be straight tubes or in a u-tube configuration. The tube may be in a single or multi-pass configuration.

As illustrated in FIG. 3, in various embodiments, the ORR electrode 104 may be in the form of a spiral wound unit 352 configuration, such as those used in ultrafiltration and reverse osmosis operations. Two structured spacing sheets 304 for every one ORR sheet 306 (or ORR membrane), and one barrier sheet 308 may form the spiral wound unit 352. The ORR sheet 306 and barrier sheets 308 would alternate, with a structured spacer between every layer. The sheets may be rolled into a spiral wound unit 352. The air 203 and electrolyte 202 may be passed through their respective sides by a distributor cap 315 affixed to the structure 352 formed when the sheets are rolled together.

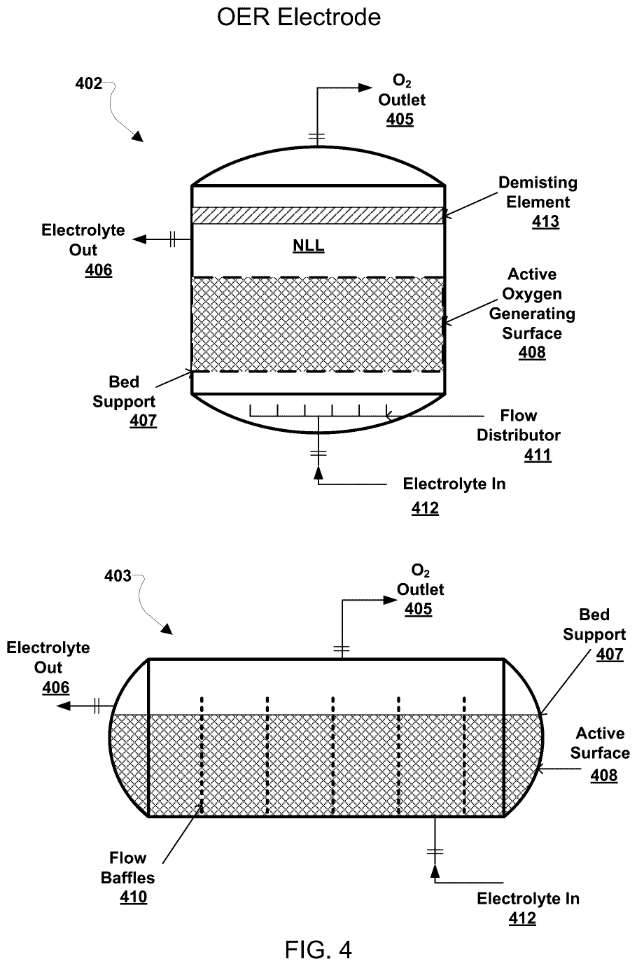

In various embodiments, the OER electrode 103 may be in any form allowing electrical continuity, vapor liquid disengagement, and electrolyte flow therein. The OER electrode 103 active material 408 may be nickel coated iron or nickel coated steel. The active material 408 may be pellets, flakes, foam, wire mesh, structure packing, dump packing, or similar. FIG. 4 illustrates a vertical vessel 402 configuration of the OER electrode 103 according to various embodiments and a horizontal vessel 403 configuration of the OER electrode 103 according to various embodiments. The active material 408 may be loaded into a vessel 402, 403 and this ‘bed’ may be supported by a permeable bed support structure 407 that is itself supported off the vessel walls. The vessel 402, 403 has at least one liquid inlet 412 and one liquid outlet 406. Electrolyte is flown into the vessel 402, 403, through the packed bed of active material 408 and out of the vessel 402, 403 via these connection points 412, 406. The electrolyte may enter the vessel 402, 403 at the bottom and exit the vessel 402, 403 above the bed of active material 408. The liquid outlet 406 may be located at the height of the desired liquid level, allowing passive liquid level control to a normal liquid level (NLL). The vessel 402, 403 head space may be wide enough to allow effective vapor liquid disengagement during oxygen evolution, which occurs at the submerged active material 408 surface and rises to the electrolyte surface via buoyancy forces. There may also be dedicated structures, vertical or horizontal, within the bed to assist with current collection. The current may be collected off the vessel 402, 403 itself. The vessel 402, 403 may be constructed of a non-electrically conductive material and therefore not participate in the current collection. There may be non-perforated baffles 410 to assist with electrolyte flow patterns. The vessel may contain a structure for flow distribution, such as a flow distributor 411, at the liquid inlet 412 or outlet 406. There may be a demisting element 413 in the vapor headspace of the vessel 402, 403. The vessel 402, 403 may include a gas outlet 405.

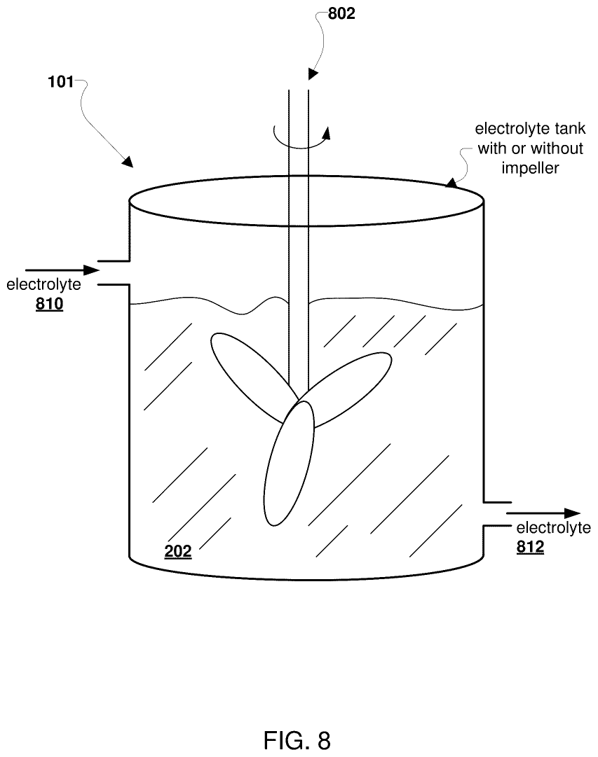

FIG. 8 illustrates an example configuration of an electrolyte vessel 101 according to various embodiments. In various embodiments, the electrolyte vessel 101, may include one or more electrolyte inlets 810 through which electrolyte 202 flows into the electrolyte vessel 101 and one or more electrolyte outlets 812 through which electrolyte 202 flows out of the electrolyte vessel 101. In an optional embodiment, an impeller 802 may be included in the electrolyte vessel 101 to stir the electrolyte 202 volume.

Flowing electrolyte through porous electrodes, such as the metal electrode 102 (e.g., an iron electrode) and/or ORR electrode 104 and/or the OER electrode 103, can improve electrochemical performance of the electrodes by improving the rate of mass transfer (reduce concentration polarization) of soluble active species to the solid electrode surface. In the case of a metal air battery (e.g., electrochemical system 100), a flowing concentrated hydroxide electrolyte will reduce the macro-boundary layer of hydroxide species approaching the active electrode surface and reduce concentration boundary layers that develop within the pores of the electrode. Increasing the mass transfer rate of soluble active species to the electrode surface will enable thicker or longer electrodes in the direction of the electrolyte transport. Thicker or longer electrodes permit greater ratios of active material to inactive material in the system (e.g., system 100).

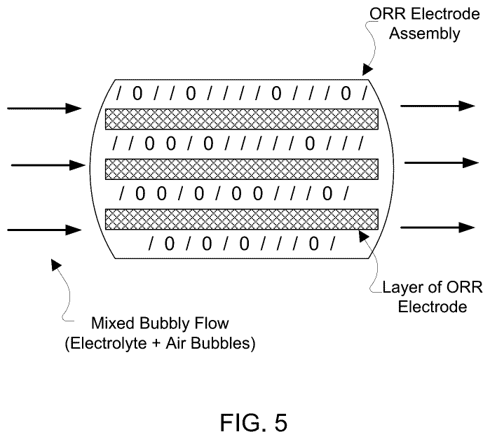

In various embodiments, the oxygen reduction reaction (ORR) electrode assembly (e.g., ORR electrode 104) may include ORR electrodes that are arranged parallel or counter to the direction of the electrolyte flow as illustrated in FIG. 5. The ORR electrode may be oriented in any direction, horizontal, vertical, diagonal or otherwise. The ORR electrode 104 may be supplied with an oxygenated electrolyte stream, a mixed bubbly (air/oxygen) and electrolyte stream, or separate gas (air/oxygen) and electrolyte streams in various embodiments.

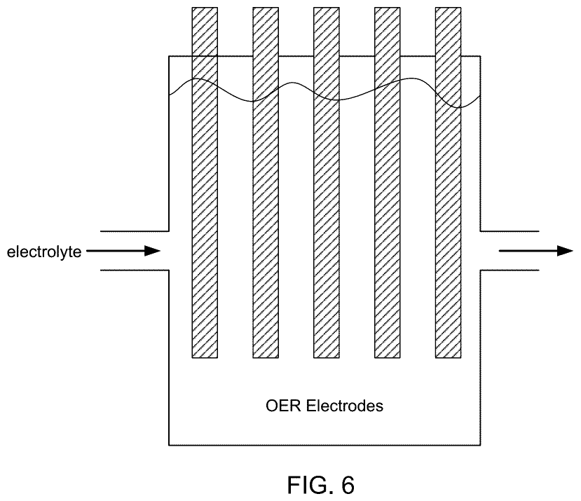

In various embodiments, the oxygen evolution reaction (OER) electrode assembly (e.g., OER electrode 103) may be comprised of OER electrodes that are submerged in a vessel as illustrated in FIG. 6. Gas released from the OER electrodes may escape through ventilation ports or pressure relief valves at the top of the vessel. The OER electrodes may be oriented horizontally, diagonally, or vertically in the vessel.

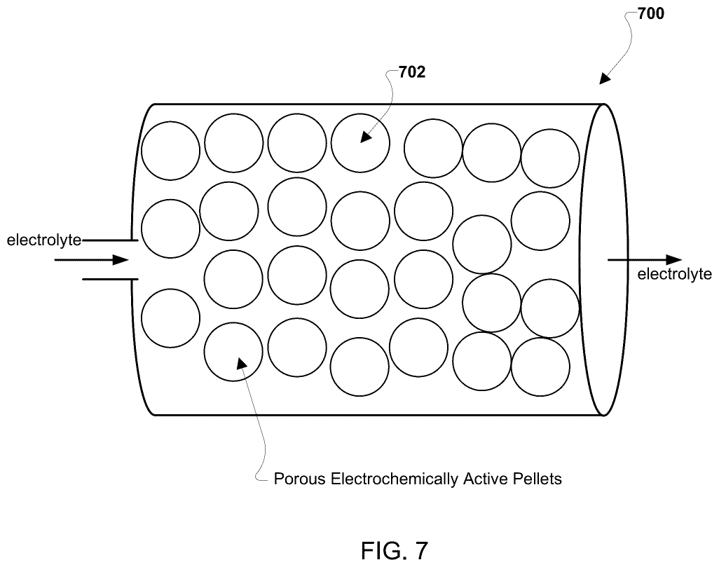

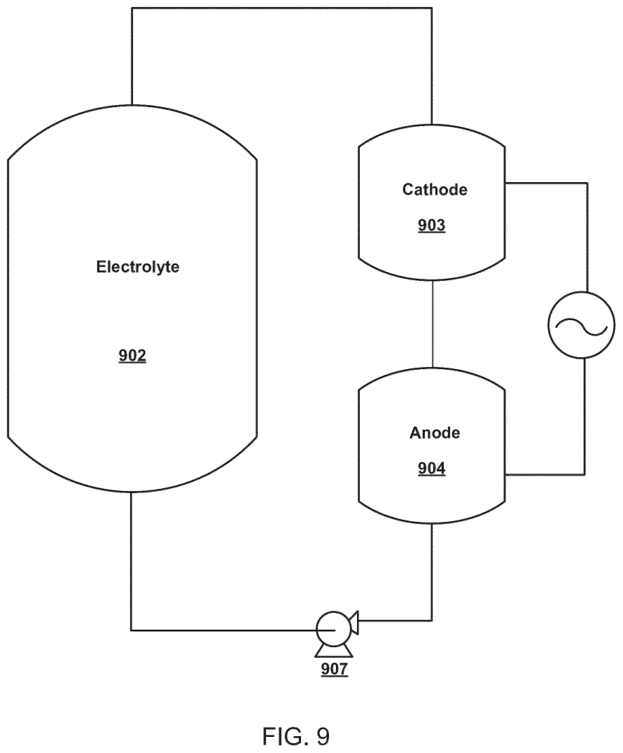

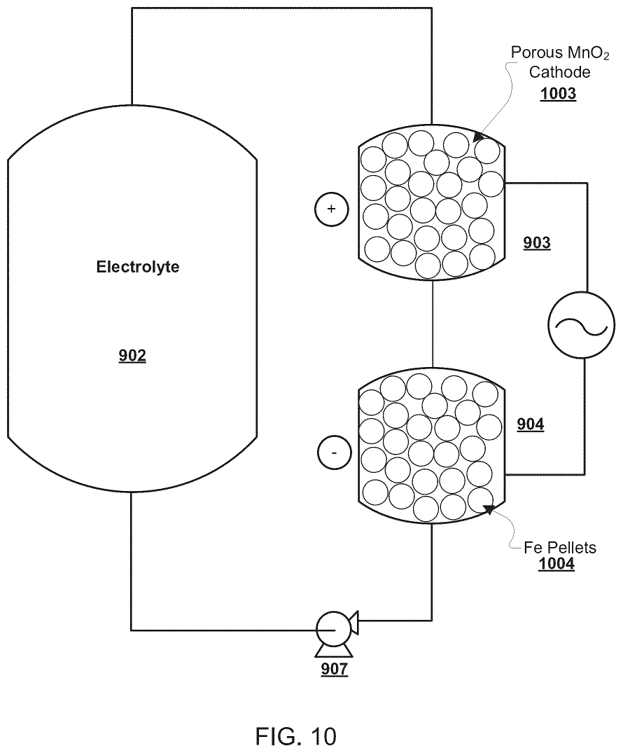

In various embodiments, the decoupled electrode energy storage system may be suitable for use with battery chemistries with solid electrode materials. For example, a solid collection of porous electrochemically active pellets 702 (or powders, or slabs, etc.) in a vessel 700 through which electrolyte flows as illustrated in FIG. 7. In this configuration, both the negative electrode and positive electrode may be comprised of porous pellets, powders, or porous slabs. FIG. 9 illustrates a simplified version of a decoupled electrode energy storage system according to various embodiments. The decoupled electrode energy storage system of FIG. 9 may include an electrolyte vessel 902, cathode vessel 903, and anode vessel 904, all fluidically connected together with electrolyte circulated through the system by a pump 907. FIG. 10 illustrates a specific example of the system of FIG. 9 in which the solid battery chemistry may be an iron and manganese dioxide (Fe/MnO₂) chemistry. The negative electrode 1004 may include iron. The negative electrode 1004 may include direct reduced iron (DRI). The negative electrode 1004 may include an iron powder, such as sponge, atomized, or carbonyl iron. The positive electrode 1003 may include manganese. The positive electrode 1003 may include MnO₂. The positive electrode 1003 may include MnO₂, carbon, and a polymer binder. The positive electrode 1003 may include pelletized MnO₂, carbon, and a polymer binder. As another example, the solid battery chemistry may be an iron and nickel (Fe/Ni) chemistry. The positive electrode 1003 may include nickel. As such, the positive electrode 1003 may include Ni, carbon, and a polymer binder rather than the MnO₂, carbon, and a polymer binder.

Various embodiments may provide a system which can achieve long duration and high current density. The system may include a fully open reactor, through which iron materials and air are flowed. The reactor may operate at higher current density, but by virtue of replenishing the active material in the reactor, may continue to operate for long durations. DRI pellets provide a near ideal anode for this fully open reactor, as DRI pellets may be definitionally flowable. In various embodiments, the iron materials may include DRI in various forms, such as pellets, spheroids, or any other flowable form. In some embodiments, the iron materials may include packed iron powder and/or sintered iron powder. In various embodiments, the iron powder included in the iron materials may be sponge iron powder and/or atomized iron powder. In various embodiments, the iron materials may include an iron powder and a polymer binder, such as sponge iron powder and a polymer binder and/or atomized iron and a powder binder. In some embodiments, the iron materials may be formed without carbon. In other words, the iron materials may not include carbon added therein, such that the iron materials do not include carbon. As specific examples, the iron materials may include sponge iron powder and a polymer binder without carbon and/or atomized iron and a powder binder without carbon. In some embodiments, the iron materials may include carbon. In other words, carbon may be an additive element selected to form at least a portion of the composition that is the iron materials. As specific examples, the iron materials may include sponge iron powder, a polymer binder, and carbon and/or the iron materials may include atomized iron, a powder binder, and carbon.

Various embodiments may provide energy storage systems with a solid metal plus oxygen chemistry. The energy storage capacity may scale with the amount of metal in the system. The system may be configured such that the energy storage capacity is decoupled from the desired power capability, which may be predominantly determined by elements other than the solid metal components.

Various embodiments may provide a metal/air energy storage system in which the metal is in a transportable form, such as a powder slurry, pellets or marbles, or any other transportable form. FIGS. 11-14 illustrate aspects of metal/air energy storage system in which the metal is in a transportable form according to various embodiments. The shape of the transportable metal may be spheroidal or not. The metal may be iron pellets. The metal may be direct reduced iron (DRI). The metal may be oxidized or reduced during charging/discharging. During these operations, the metal may be brought in close proximity to the counter air electrodes, and it is here that the desired reaction takes place. The metal may be carried away in its desired state (oxidized or reduced) to a storage containment vessel of some kind. The metal movement/flow may be continuous, batch, or semi-batch.

FIG. 11 illustrates a metal/air energy storage system 1100 in which a flow of metal pellets 1102, such as DRI pellets, passes through a metal flow passage 1101 toward an air electrode 1104. A separator 1105 may keep the metal pellets 1102 from contacting the air electrode 1104. The metal pellets 1102 may be circulated in a flow direction past the air electrode 1104. The metal pellets 1102 flowing through the metal flow passage 1101 may constitute the metal electrode in the system 1100.

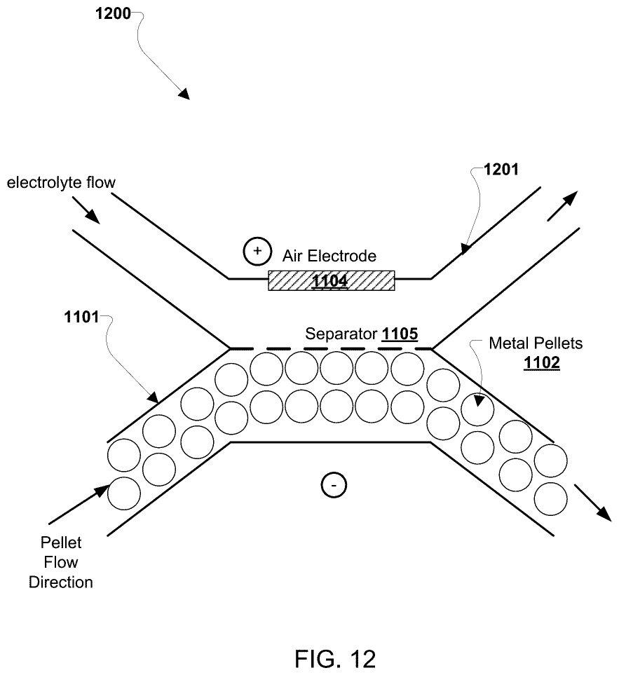

The metal electrode may be paired in an electrochemical cell with one or more air electrodes 1104 serving as the counter electrode, which may act as the positive electrode of a secondary battery. The air electrode 1104 may be bifunctional, in that it engages the oxygen reduction reaction (ORR) and the oxygen evolution reaction (OER). FIG. 12 illustrates an alternative configuration 1200 in which an electrolyte flow passage 1201 flows electrolyte between the air electrode 104 and the separator 1105.

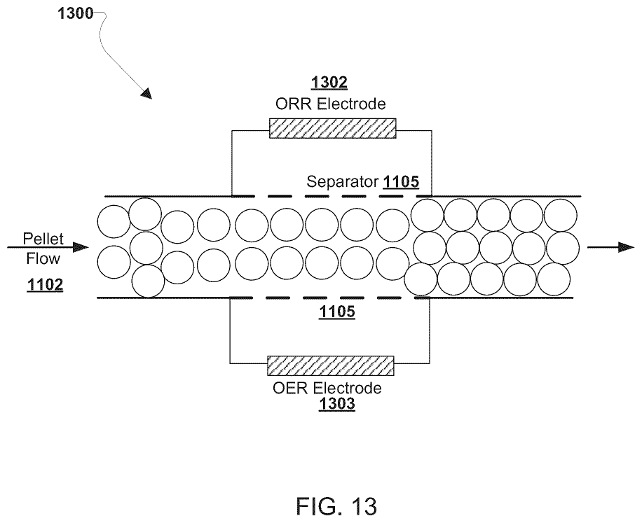

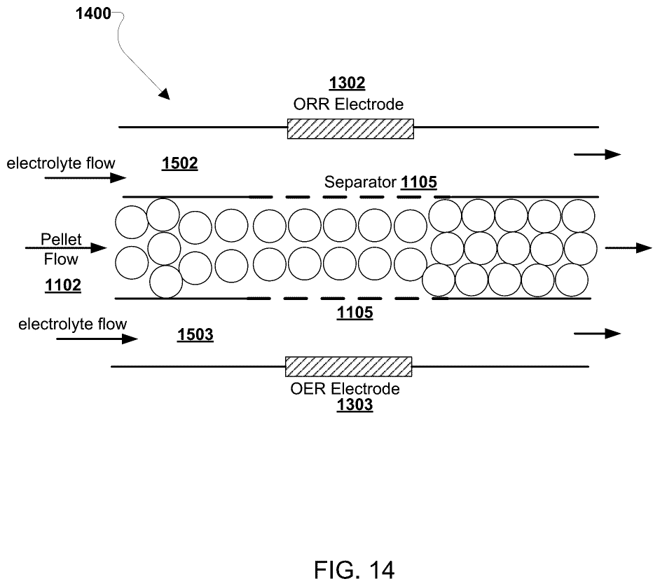

In various embodiments, such as those illustrated in FIGS. 13 and 14, there may be two air electrodes, such as an ORR electrode 1302 and an OER electrode 1303. The discharge air electrode 1302 may engage the ORR. The charge air electrode 1303 may engage the OER. When two air electrodes 1302, 1303 are employed, an external switch can be used to toggle between charge and discharge mode. Electrolyte may or may not be forced to flow past the air electrode(s) 1302, 1303. For example, FIG. 13 illustrates a system 1300 in which electrolyte does not flow past the air electrodes 1302, 1303, while FIG. 14 illustrates a system 1400 in which electrolyte flow passages 1502 and 1503 flow electrolyte past the air electrodes 1302, 1303, respectively. The air electrode(s) 1302, 1303 may be electrically isolated from the flowing metal pellets 1102 by a porous insulating layer (e.g., separator 1105).

Various embodiments are discussed in relation to the use of direct reduced iron (DRI) as a material in an electrochemical system (e.g., a battery (or cell), etc.), as a component of an electrochemical system (e.g., a battery (or cell), etc.), and combinations and variations of these. In various embodiments, the DRI may be produced from, or may be, material which is obtained from the reduction of natural or processed iron ores, such reduction being conducted without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal (Fe⁰), wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 3 below. As used in the Specification, including Table 3, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass. Weight and volume percentages and apparent densities as used herein are understood to exclude any electrolyte that has infiltrated porosity or fugitive additives within porosity unless otherwise stated.

TABLE 3

| Material Property | Embodiment Range |
|---|---|
| Specific surface area* | 0.01-25 m²/g |
| Actual density** | 4.6-7.1 g/cc |
| Apparent density*** | 2.3-6.5 g/cc |
| Minimum d_{pore, 90% volume}**** | 10 nm-50 μm |
| Minimum d_{pore, 50% surface area}***** | 1 nm-15 μm |
| Total Fe (wt %)^{#} | 65-95% |
| Metallic Fe (wt %)^{##} | 46-90% |
| Metallization (%)^{###} | 59-96% |
| Carbon (wt %)^{####} | 0-5% |
| Fe²⁺ (wt %)^{#####} | 1-9% |
| Fe³⁺ (wt %)^{$} | 0.9-25% |
| SiO₂ (wt %)^{$$} | 1-15% |
| Ferrite (wt %, XRD)^{$$$} | 22-97% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | << 80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) - Metallic Fe (wt %) - Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the
SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 3A.

TABLE 3A

| | | | | |
|---|---|---|---|---|
| Fe total (wt %)^{!} | > 60% | > 70% | > 80% | ~83-94% |
| SiO₂ (wt %)^{!!} | < 12% | < 7.5% | 1-10% | 1.5-7.5% |
| A1₂O₃ (wt %)^{!!!} | < 10% | < 5% | 0.2-5% | 0.3-3% |
| MgO (wt %)^{!!!!} | < 10% | < 5% | 0.1-10% | 0.25-2% |
| CaO (wt %)^{!!!!!} | < 10% | < 5% | 0.9-10% | 0.75-2.5% |
| TiO₂ (wt %)^{&} | < 10% | <2.5% | 0.05-5% | 0.25-1.5% |
| Size (largest | < 200 mm | ~50 to ~150 mm | ~2 to ~30 mm | ~4 to ~20 mm |
| cross-sectional | | | | |
| distance, e.g. for | | | | |
| a sphere the | | | | |
| diameter) | | | | |
| Actual Density | ~5 | ~5.8 to ~6.2 | ~4.0 to ~6.5 | < 7.8 |
| (g/cm³)^{&&} | | | | |
| Apparent | < 7.8 | > 5 | > 4 | 3.4~3.6 |
| Density | | | | |
| (g/cm³)^{&&&} | | | | |
| Bulk Density | < 7 | > 1.5 | ~2.4 to ~3.4 | ~1.5 to ~2.0 |
| (kg/m³)^{&&&&} | | | | |
| Porosity | >15% | >50% | ~ 20% to ~90% | ~50% to ~70% |
| (%)^{&&&&&} | | | | |

^{!}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with
dichromate titrimetry.
^{!!}SiO₂ (wt %) preferably determined by gravimetric methods, and more preferably asis set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{!!!}A1₂O₃ (wt %) preferably determined by flame atomic absorption spectrometric method, and more preferably as is set forth in ISO 4688-1 (the entire disclosure of which is incorporated herein by reference); recognizing that other tests, such as x-ray diffraction (XRD), may be employed to provide results that can be correlated with flame atomic absorption spectrometric method. In certain methods, the Al₂O₃ wt % is not determined directly, but rather the Al concentration (inclusive of neutral and ionic species) is measured, and the Al₂O₃ wt % is calculated assuming the stoichiometry of Al₂O₃; that is, a 2:3 molar ratio of Al:O is assumed.
^{!!!!}MgO (wt %) preferably determined by flame atomic absorption spectrometric method, and more preferably as is set forth in ISO 10204 (the entire disclosure of which is incorporated herein by reference); recognizing that other tests, such as x-ray diffraction (XRD), may be employed to provide results that can be correlated with flame atomic absorption spectrometric method. In certain methods, the MgO wt % is not determined directly, but rather the Mg concentration (inclusive of neutral and ionic species) is measured, and the MgO wt % is calculated assuming the stoichiometry of MgO; that is, a 1:1 molar ratio of Mg:O is assumed.
^{!!!!!}CaO (wt %) preferably determined by flame atomic absorption spectrometric method, and more preferably as is set forth in ISO 10203 (the entire disclosure of which is incorporated herein by reference); recognizing that other tests, such as x-ray diffraction (XRD), may be employed to provide results that can be correlated with flame atomic absorption spectrometric method. In certain methods, the CaO wt % is not determined directly, but rather the Ca concentration (inclusive of neutral and ionic species) is measured, and the CaO wt % is calculated assuming the stoichiometry of CaO; that is, a 1:1 molar ratio of Ca:O is assumed.
^{&}TiO₂ (wt %) preferably determined by a diantipyrylmethane spectrophotometric method, and more preferably as is set forth in ISO 4691 (the entire disclosure of which is incorporated herein by reference); recognizing that other tests, such as x-ray diffraction (XRD), may be employed to provide results that can be correlated with the diantipyrylmethane spectrophotometric method method. In certain methods, the TiO₂ wt % is not determined directly, but rather the Ti concentration (inclusive of neutral and ionic species) is measured, and the TiO₂ wt % is calculated assuming the stoichiometry of TiO₂; that is, a 1:2 molar ratio of Ti:O is assumed.
^{&&}Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
^{&&&}Apparent density preferably determined by immersion in water, and more preferably as is set forth in ISO 15968 (the entire disclosure of which is incorporated herein by reference); recognizing that other tests may be employed to provide results that can be correlated with He pycnometry results.
^{&&&&}Bulk Density (kg/m³) preferably determined by measuring the mass of a test portion introduced into a container of known volume until its surface is level, and more preferably as is set forth in Method 2 of ISO 3852 (the entire disclosure of which is incorporated herein by reference); recognizing that other tests may be employed to provide results that can be correlated with the massing method.
^{&&&&&}Porosity determined preferably by the ratio of the apparent density to the actual density:
$Porosity = \frac{apparent density}{actual density}$

The properties set forth in Table 3, may also be present in embodiments with, in addition to, or instead of the properties in Table 3A. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. Iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 4 below. The use of reduced BF grade DRI may be advantageous due to the lesser input energy required to produce the pellet, which translates to a lower cost of the finished material.

TABLE 4

| Material Property | Embodiment Range |
|---|---|
| Specific surface area* | 0.21-25 m²/g |
| Actual density** | 5.5-6.7 g/cc |
| Apparent density*** | 3.1-4.8 g/cc |
| Minimum d_{pore, 90% volume}**** | 50 nm-50 μm |
| Minimum d_{pore, 50% surface area}****** | 1 nm-10 μm |
| Total Fe (wt %)^{#} | 81.8-89.2% |
| Metallic Fe (wt %)^{##} | 68.7-83.2% |
| Metallization (%)^{###} | 84-95% |
| Carbon (wt %)^{###} | 0.03-0.35% |
| Fe²⁺ (wt %)^{#####} | 2-8.7% |
| Fe³⁺ (wt %)^{$} | 0.9-5.2% |
| SiO₂ (wt %)^{$$} | 3-7% |
| Ferrite (wt %, XRD)^{$$$} | 80-96% |
| Wustite (FeO, wt %, XRD)^{$$$$} | 2-13% |
| Goethite (FeOOH, wt %, XRD)^{$$$$$} | 0-11% |
| Cementite (Fe₃C, wt %, XRD)⁺ | 0-80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) - Metallic Fe (wt %) - Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

The properties set forth in Table 4, may also be present in embodiments with, in addition to, or instead of the properties in Tables 3 and/or 3A. Greater and lesser values for these properties may also be present in various embodiments.

In certain embodiments the DRI may be produced by the reduction of a DR Grade pellet, in which case the resulting DRI may have material properties as described in Table 5 below. The use of reduced DR grade DRI may be advantageous due to the higher Fe content in the pellet which increases the energy density of the battery.

TABLE 5

| Material Property | Embodiment Range |
|---|---|
| Specific surface area* | 0.1-0.7 m²/g as received or 0.19-25 m²/g |
| | after performing a pre-charge formation step |
| Actual density** | 4.6-7.1 g/cc |
| Apparent density*** | 2.3-5.7 g/cc |
| Minimum d_{pore, 90% volume}**** | 50 nm-50 um |
| Minimum d_{pore, 50% surface area}***** | 1 nm-10 um |
| Total Fe (wt %)^{#} | 80-94% |
| Metallic Fe (wt %)^{##} | 64-94% |
| Metallization (%)^{###} | 80-100% |
| Carbon (wt %)^{####} | 0-5% |
| Fe²⁺ (wt %)^{#####} | 0-8% |
| Fe³⁺ (wt %)^{$} | 0-10% |
| SiO₂ (wt %)^{$$} | 1-4% |
| Ferrite (wt %, XRD)^{$$$} | 22-80% |
| Wustite (FeO, wt %, XRD)^{$$$$} | 0-13% |
| Goethite (FeOOH, wt %, XRD)^{$$$$$} | 0-23% |
| Cementite (Fe3C, wt %, XRD)⁺ | << 80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface} ₐᵣₑₐ preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg
intrusion results. d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) - Metallic Fe (wt %) - Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

The properties set forth in Table 5, may also be present in embodiments with, in addition to, or instead of the properties in Tables 3, 3A, and/or 4. Greater and lesser values for these properties may also be present in various embodiments.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

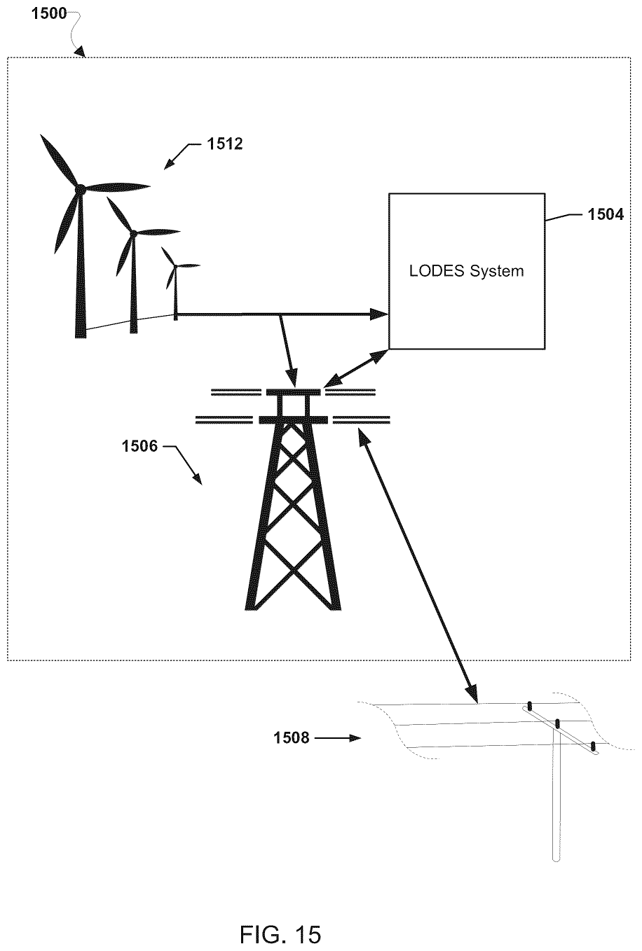

FIGS. 15-23 illustrate various example systems in which one or more aspects of the various embodiments may be used as part of bulk energy storage systems, such as LODES systems, SDES systems, etc. For example, various embodiments described herein with reference to FIGS. 1-14 may be used as batteries and/or systems for bulk energy storage systems, such as LODES systems, SDES systems, etc. and/or various components, such as various electrodes, as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 15 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a wind farm 1512 and one or more transmission facilities 1506. The wind farm 1512 may be electrically connected to the transmission facilities 1506. The transmission facilities 1506 may be electrically connected to the grid 1508. The wind farm 1512 may generate power and the wind farm 1512 may output generated power to the LODES system 1504 and/or the transmission facilities 1506. The LODES system 1504 may store power received from the wind farm 1512 and/or the transmission facilities 1506. The LODES system 1504 may output stored power to the transmission facilities 1506. The transmission facilities 1506 may output power received from one or both of the wind farm 1512 and LODES system 1504 to the grid 1508 and/or may receive power from the grid 1508 and output that power to the LODES system 1504. Together the wind farm 1512, the LODES system 1504, and the transmission facilities 1506 may constitute a power plant 1500 that may be a combined power generation, transmission, and storage system. The power generated by the wind farm 1512 may be directly fed to the grid 1508 through the transmission facilities 1506, or may be first stored in the LODES system 1504. In certain cases the power supplied to the grid 1508 may come entirely from the wind farm 1512, entirely from the LODES system 1504, or from a combination of the wind farm 1512 and the LODES system 1504. The dispatch of power from the combined wind farm 1512 and LODES system 1504 power plant 1500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1500, the LODES system 1504 may be used to reshape and “firm” the power produced by the wind farm 1512. In one such example, the wind farm 1512 may have a peak generation output (capacity) of 260 megawatts (MW) and a capacity factor (CF) of 41%. The LODES system 1504 may have a power rating (capacity) of 106 MW, a rated duration (energy/power ratio) of 150 hours (h), and an energy rating of 15,900 megawatt hours (MWh). In another such example, the wind farm 1512 may have a peak generation output (capacity) of 300 MW and a capacity factor (CF) of 41%. The LODES system 1504 may have a power rating of 106 MW, a rated duration (energy/power ratio) of 200 h and an energy rating of 21,200 MWh. In another such example, the wind farm 1512 may have a peak generation output (capacity) of 176 MW and a capacity factor (CF) of 53%. The LODES system 1504 may have a power rating (capacity) of 88 MW, a rated duration (energy/power ratio) of 150 h and an energy rating of 13,200 MWh. In another such example, the wind farm 1512 may have a peak generation output (capacity) of 277 MW and a capacity factor (CF) of 41%. The LODES system 1504 may have a power rating (capacity) of 97 MW, a rated duration (energy/power ratio) of 50 h and an energy rating of 4,850 MWh. In another such example, the wind farm 1512 may have a peak generation output (capacity) of 315 MW and a capacity factor (CF) of 41%. The LODES system 1504 may have a power rating (capacity) of 110 MW, a rated duration (energy/power ratio) of 25 h and an energy rating of 2,750 MWh.

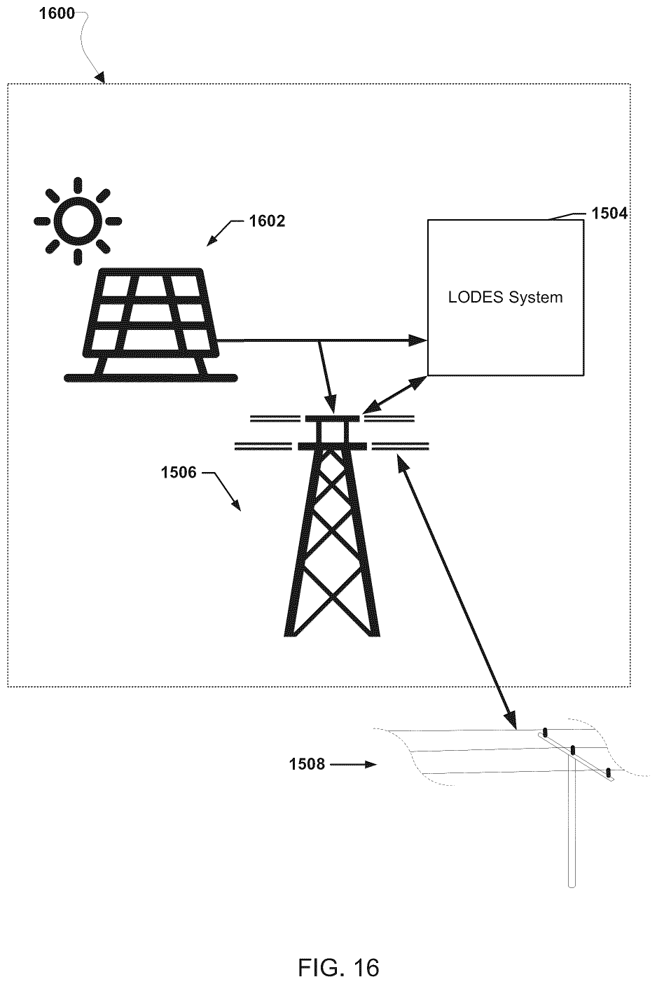

FIG. 16 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The system of FIG. 16 may be similar to the system of FIG. 15, except a photovoltaic (PV) farm 1602 may be substituted for the wind farm 1512. The LODES system 1504 may be electrically connected to the PV farm 1602 and one or more transmission facilities 1506. The PV farm 1602 may be electrically connected to the transmission facilities 1506. The transmission facilities 1506 may be electrically connected to the grid 1508. The PV farm 1602 may generate power and the PV farm 1602 may output generated power to the LODES system 1504 and/or the transmission facilities 1506. The LODES system 1504 may store power received from the PV farm 1602 and/or the transmission facilities 1506. The LODES system 1504 may output stored power to the transmission facilities 1506. The transmission facilities 1506 may output power received from one or both of the PV farm 1602 and LODES system 1504 to the grid 1508 and/or may receive power from the grid 1508 and output that power to the LODES system 1504. Together the PV farm 1602, the LODES system 1504, and the transmission facilities 1506 may constitute a power plant 1600 that may be a combined power generation, transmission, and storage system. The power generated by the PV farm 1602 may be directly fed to the grid 1508 through the transmission facilities 1506, or may be first stored in the LODES system 1504. In certain cases the power supplied to the grid 1508 may come entirely from the PV farm 1602, entirely from the LODES system 1504, or from a combination of the PV farm 1602 and the LODES system 1504. The dispatch of power from the combined PV farm 1602 and LODES system 1504 power plant 1600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1600, the LODES system 1504 may be used to reshape and “firm” the power produced by the PV farm 1602. In one such example, the PV farm 1602 may have a peak generation output (capacity) of 490 MW and a capacity factor (CF) of 24%. The LODES system 1504 may have a power rating (capacity) of 340 MW, a rated duration (energy/power ratio) of 150 h and an energy rating of 51,000 MWh. In another such example, the PV farm 1602 may have a peak generation output (capacity) of 680 MW and a capacity factor (CF) of 24%. The LODES system 1504 may have a power rating (capacity) of 410 MW, a rated duration (energy/power ratio) of 200 h, and an energy rating of 82,000 MWh. In another such example, the PV farm 1602 may have a peak generation output (capacity) of 330 MW and a capacity factor (CF) of 31%. The LODES system 1504 may have a power rating (capacity) of 215 MW, a rated duration (energy/power ratio) of 150 h, and an energy rating of 32,250 MWh. In another such example, the PV farm 1602 may have a peak generation output (capacity) of 510 MW and a capacity factor (CF) of 24%. The LODES system 1504 may have a power rating (capacity) of 380 MW, a rated duration (energy/power ratio) of 50 h, and an energy rating of 19,000 MWh. In another such example, the PV farm 1602 may have a peak generation output (capacity) of 630 MW and a capacity factor (CF) of 24%. The LODES system 1504 may have a power rating (capacity) of 380 MW, a rated duration (energy/power ratio) of 25 h, and an energy rating of 9,500 MWh.

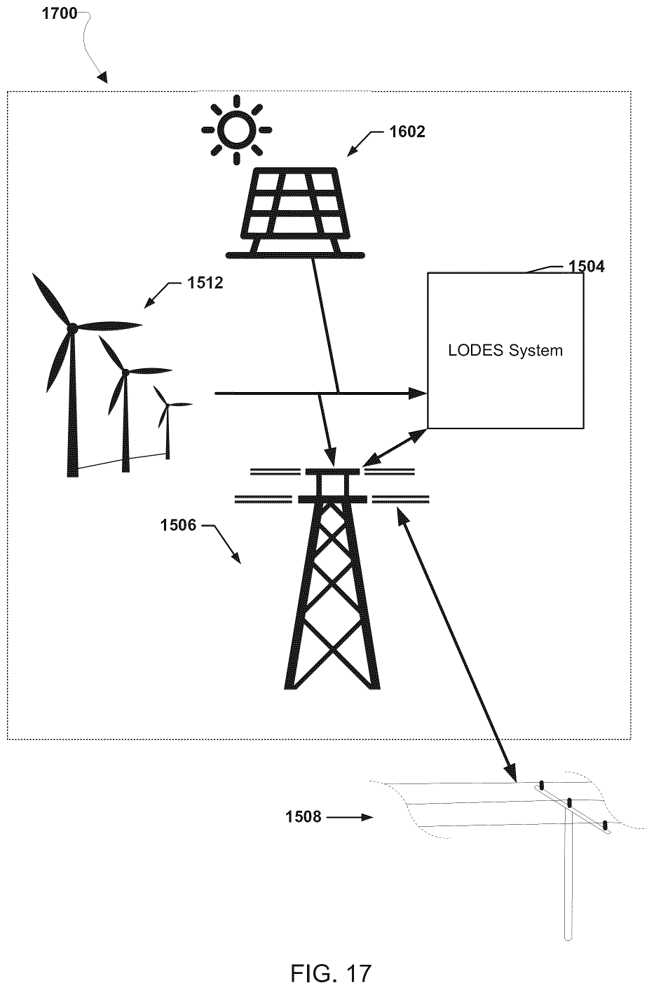

FIG. 17 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The system of FIG. 17 may be similar to the systems of FIGS. 15 and 16, except the wind farm 1512 and the photovoltaic (PV) farm 1602 may both be power generators working together in the power plant 1700. Together the PV farm 1602, wind farm 1512, the LODES system 1504, and the transmission facilities 1506 may constitute the power plant 1700 that may be a combined power generation, transmission, and storage system. The power generated by the PV farm 1602 and/or the wind farm 1512 may be directly fed to the grid 1508 through the transmission facilities 1506, or may be first stored in the LODES system 1504. In certain cases the power supplied to the grid 1508 may come entirely from the PV farm 1602, entirely from the wind farm 1512, entirely from the LODES system 1504, or from a combination of the PV farm 1602, the wind farm 1512, and the LODES system 1504. The dispatch of power from the combined wind farm 1512, PV farm 1602, and LODES system 1504 power plant 1700 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1700, the LODES system 1504 may be used to reshape and “firm” the power produced by the wind farm 1512 and the PV farm 1602. In one such example, the wind farm 1512 may have a peak generation output (capacity) of 126 MW and a capacity factor (CF) of 41% and the PV farm 1602 may have a peak generation output (capacity) of 126 MW and a capacity factor (CF) of 24%. The LODES system 1504 may have a power rating (capacity) of 63 MW, a rated duration (energy/power ratio) of 150 h, and an energy rating of 9,450 MWh. In another such example, the wind farm 1512 may have a peak generation output (capacity) of 170 MW and a capacity factor (CF) of 41% and the PV farm 1602 may have a peak generation output (capacity) of 110 MW and a capacity factor (CF) of 24%. The LODES system 1504 may have a power rating (capacity) of 57 MW, a rated duration (energy/power ratio) of 200 h, and an energy rating of 11,400 MWh. In another such example, the wind farm 1512 may have a peak generation output (capacity) of 105 MW and a capacity factor (CF) of 51% and the PV farm 1602 may have a peak generation output (capacity) of 70 MW and a capacity factor (CF) of 31 The LODES system 1504 may have a power rating (capacity) of 61 MW, a rated duration (energy/power ratio) of 150 h, and an energy rating of 9,150 MWh. In another such example, the wind farm 1512 may have a peak generation output (capacity) of 135 MW and a capacity factor (CF) of 41% and the PV farm 1602 may have a peak generation output (capacity) of 90 MW and a capacity factor (CF) of 24%. The LODES system 1504 may have a power rating (capacity) of 68 MW, a rated duration (energy/power ratio) of 50 h, and an energy rating of 3,400 MWh. In another such example, the wind farm 1512 may have a peak generation output (capacity) of 144 MW and a capacity factor (CF) of 41% and the PV farm 1602 may have a peak generation output (capacity) of 96 MW and a capacity factor (CF) of 24%. The LODES system 1504 may have a power rating (capacity) of 72 MW, a rated duration (energy/power ratio) of 25 h, and an energy rating of 1,800 MWh.

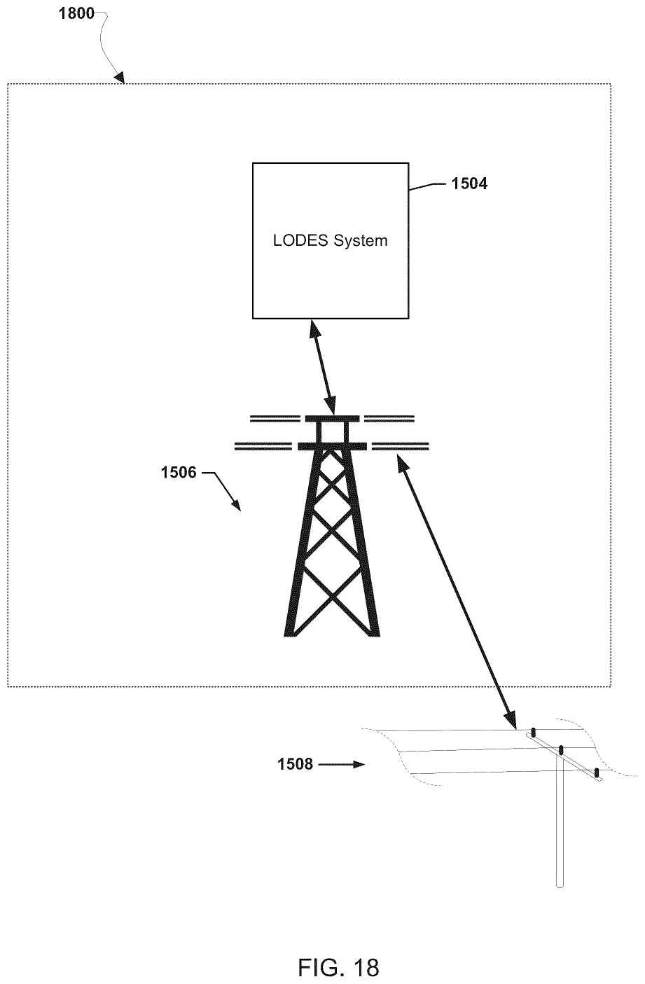

FIG. 18 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to one or more transmission facilities 1506. In this manner, the LODES system 1504 may operate in a “stand-alone” manner to arbiter energy around market prices and/or to avoid transmission constraints. The LODES system 1504 may be electrically connected to one or more transmission facilities 1506. The transmission facilities 1506 may be electrically connected to the grid 1508. The LODES system 1504 may store power received from the transmission facilities 1506. The LODES system 1504 may output stored power to the transmission facilities 1506. The transmission facilities 1506 may output power received from the LODES system 1504 to the grid 1508 and/or may receive power from the grid 1508 and output that power to the LODES system 1504.

Together the LODES system 1504 and the transmission facilities 1506 may constitute a power plant 1800. As an example, the power plant 1800 may be situated downstream of a transmission constraint, close to electrical consumption. In such an example downstream situated power plant 1800, the LODES system 1504 may have a duration of 24 h to 500 h and may undergo one or more full discharges a year to support peak electrical consumptions at times when the transmission capacity is not sufficient to serve customers. Additionally in such an example downstream situated power plant 1800, the LODES system 1504 may undergo several shallow discharges (daily or at higher frequency) to arbiter the difference between nighttime and daytime electricity prices and reduce the overall cost of electrical service to customer. As a further example, the power plant 1800 may be situated upstream of a transmission constraint, close to electrical generation. In such an example upstream situated power plant 1800, the LODES system 1504 may have a duration of 24 h to 500 h and may undergo one or more full charges a year to absorb excess generation at times when the transmission capacity is not sufficient to distribute the electricity to customers. Additionally in such an example upstream situated power plant 1800, the LODES system 1504 may undergo several shallow charges and discharges (daily or at higher frequency) to arbiter the difference between nighttime and daytime electricity prices and maximize the value of the output of the generation facilities.

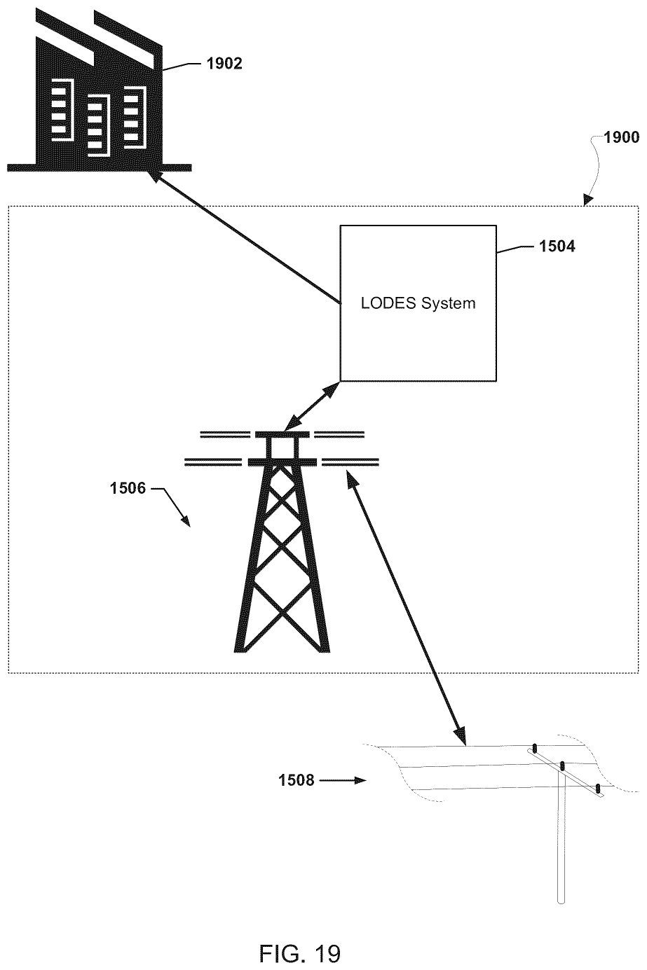

FIG. 19 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a commercial and industrial (C&I) customer 1902, such as a data center, factory, etc. The LODES system 1504 may be electrically connected to one or more transmission facilities 1506. The transmission facilities 1506 may be electrically connected to the grid 1508. The transmission facilities 1506 may receive power from the grid 1508 and output that power to the LODES system 1504. The LODES system 1504 may store power received from the transmission facilities 1506. The LODES system 1504 may output stored power to the C&I customer 1902. In this manner, the LODES system 1504 may operate to reshape electricity purchased from the grid 1508 to match the consumption pattern of the C&I customer 1902.

Together, the LODES system 1504 and transmission facilities 1506 may constitute a power plant 1900. As an example, the power plant 1900 may be situated close to electrical consumption, i.e., close to the C&I customer 1902, such as between the grid 1508 and the C&I customer 1902. In such an example, the LODES system 1504 may have a duration of 24 h to 500 h and may buy electricity from the markets and thereby charge the LODES system 1504 at times when the electricity is cheaper. The LODES system 1504 may then discharge to provide the C&I customer 1902 with electricity at times when the market price is expensive, therefore offsetting the market purchases of the C&I customer 1902. As an alternative configuration, rather than being situated between the grid 1508 and the C&I customer 1902, the power plant 1900 may be situated between a renewable source, such as a PV farm, wind farm, etc., and the transmission facilities 1506 may connect to the renewable source. In such an alternative example, the LODES system 1504 may have a duration of 24 h to 500 h, and the LODES system 1504 may charge at times when renewable output may be available. The LODES system 1504 may then discharge to provide the C&I customer 1902 with renewable generated electricity so as to cover a portion, or the entirety, of the C&I customer 1902 electricity needs.

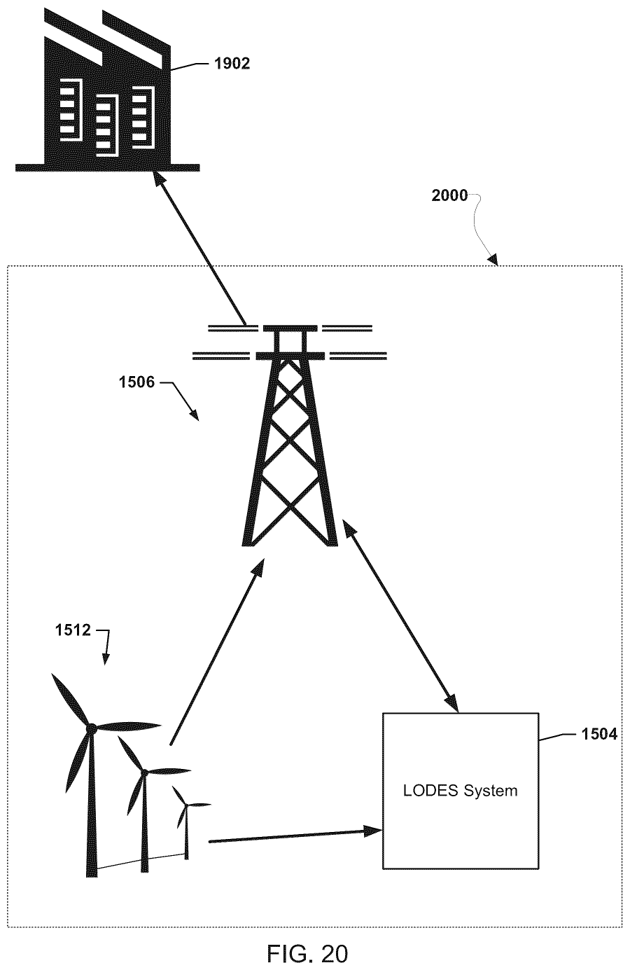

FIG. 20 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a wind farm 1512 and one or more transmission facilities 1506. The wind farm 1512 may be electrically connected to the transmission facilities 1506. The transmission facilities 1506 may be electrically connected to a C&I customer 1902. The wind farm 1512 may generate power and the wind farm 1512 may output generated power to the LODES system 1504 and/or the transmission facilities 1506. The LODES system 1504 may store power received from the wind farm 1512.

The LODES system 1504 may output stored power to the transmission facilities 1506. The transmission facilities 1506 may output power received from one or both of the wind farm 1512 and LODES system 1504 to the C&I customer 1902. Together the wind farm 1512, the LODES system 1504, and the transmission facilities 1506 may constitute a power plant 2000 that may be a combined power generation, transmission, and storage system. The power generated by the wind farm 1512 may be directly fed to the C&I customer 1902 through the transmission facilities 1506, or may be first stored in the LODES system 1504. In certain cases, the power supplied to the C&I customer 1902 may come entirely from the wind farm 1512, entirely from the LODES system 1504, or from a combination of the wind farm 1512 and the LODES system 1504. The LODES system 1504 may be used to reshape the electricity generated by the wind farm 1512 to match the consumption pattern of the C&I customer 1902. In one such example, the LODES system 1504 may have a duration of 24 h to 500 h and may charge when renewable generation by the wind farm 1512 exceeds the C&I customer 1902 load. The LODES system 1504 may then discharge when renewable generation by the wind farm 1512 falls short of C&I customer 1902 load so as to provide the C&I customer 1902 with a firm renewable profile that offsets a fraction, or all of, the C&I customer 1902 electrical consumption.

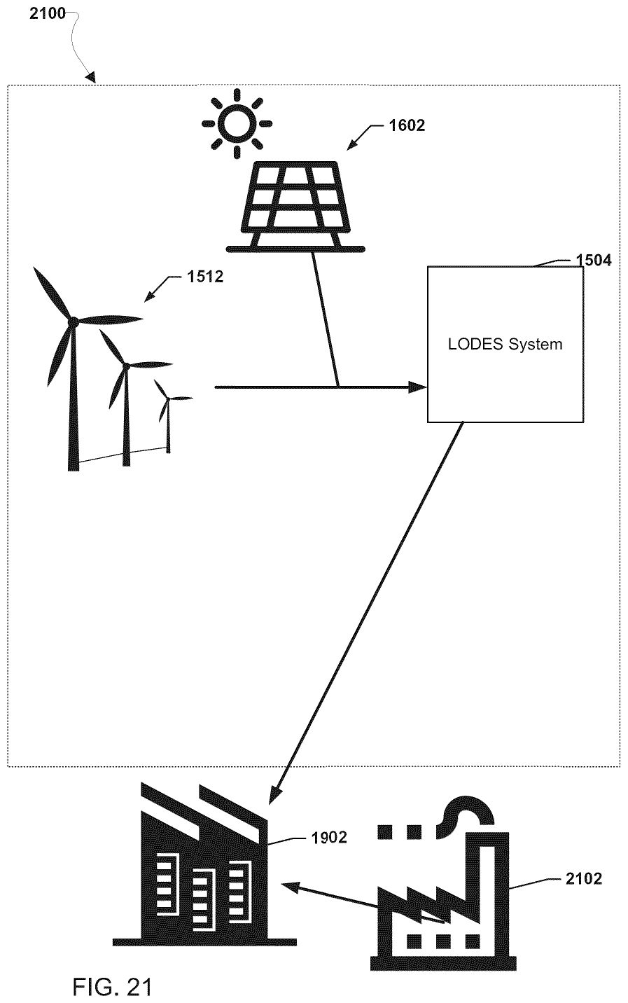

FIG. 21 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be part of a power plant 2100 that is used to integrate large amounts of renewable generation in microgrids and harmonize the output of renewable generation by, for example a PV farm 1602 and wind farm 1512, with existing thermal generation by, for example a thermal power plant 2102 (e.g., a gas plant, a coal plant, a diesel generator set, etc., or a combination of thermal generation methods), while renewable generation and thermal generation supply the C&I customer 1902 load at high availability. Microgrids, such as the microgrid constituted by the power plant 2100 and the thermal power plant 2102, may provide availability that is 90% or higher. The power generated by the PV farm 1602 and/or the wind farm 1512 may be directly fed to the C&I customer 1902, or may be first stored in the LODES system 1504.

In certain cases the power supplied to the C&I customer 1902 may come entirely from the PV farm 1602, entirely from the wind farm 1512, entirely from the LODES system 1504, entirely from the thermal power plant 902, or from any combination of the PV farm 1602, the wind farm 1512, the LODES system 1504, and/or the thermal power plant 2102. As examples, the LODES system 1504 of the power plant 2100 may have a duration of 24 h to 500 h. As a specific example, the C&I customer 1902 load may have a peak of 100 MW, the LODES system 1504 may have a power rating of 14 MW and duration of 150 h, natural gas may cost $6/million British thermal units (MMBTU), and the renewable penetration may be 58%. As another specific example, the C&I customer 1902 load may have a peak of 100 MW, the LODES system 1504 may have a power rating of 25 MW and duration of 150 h, natural gas may cost $8/MMBTU, and the renewable penetration may be 65%.

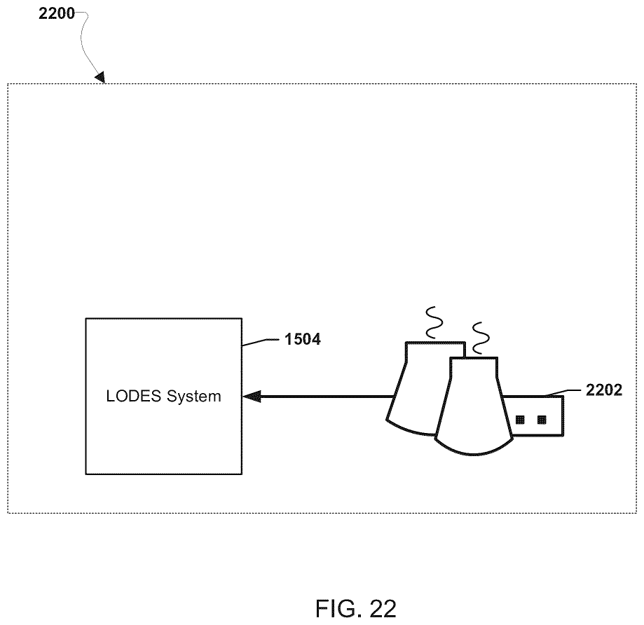

FIG. 22 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be used to augment a nuclear plant 2202 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 2200 constituted by the combined LODES system 1504 and nuclear plant 2202. The nuclear plant 2202 may operate at high capacity factor and at the highest efficiency point, while the LODES system 1504 may charge and discharge to effectively reshape the output of the nuclear plant 2202 to match a customer electrical consumption and/or a market price of electricity. As examples, the LODES system 1504 of the power plant 2200 may have a duration of 24 h to 500 h. In one specific example, the nuclear plant 2202 may have 1,000 MW of rated output and the nuclear plant 2202 may be forced into prolonged periods of minimum stable generation or even shutdowns because of depressed market pricing of electricity. The LODES system 1504 may avoid facility shutdowns and charge at times of depressed market pricing; and the LODES system 1504 may subsequently discharge and boost total output generation at times of inflated market pricing.

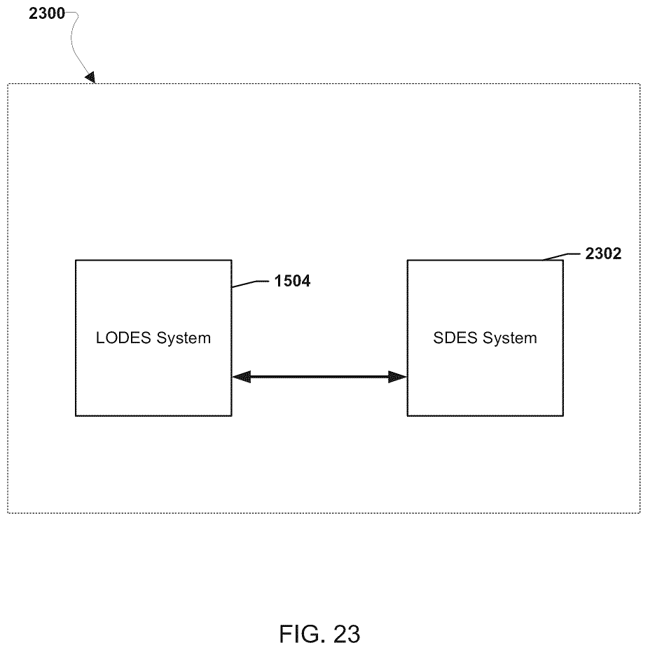

FIG. 23 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may operate in tandem with a SDES system 2302. Together the LODES system 1504 and SDES system 2302 may constitute a power plant 2300. As an example, the LODES system 1504 and SDES system 2302 may be co-optimized whereby the LODES system 1504 may provide various services, including long-duration back-up and/or bridging through multi-day fluctuations (e.g., multi-day fluctuations in market pricing, renewable generation, electrical consumption, etc.), and the SDES system 2302 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 2302 may have durations of less than 10 hours and round-trip efficiencies of greater than 80%. The LODES system 1504 may have durations of 24 h to 500 h and round-trip efficiencies of greater than 40%. In one such example, the LODES system 1504 may have a duration of 150 hours and support customer electrical consumption for up to a week of renewable under-generation. The LODES system 1504 may also support customer electrical consumption during intra-day under-generation events, augmenting the capabilities of the SDES system 2302. Further, the SDES system 2302 may supply customers during intra-day under-generation events and provide power conditioning and quality services such as voltage control and frequency regulation.

Example 1. A metal/air energy storage system, comprising: a metal electrode vessel, the metal electrode vessel comprising a bed of metal; at least one other electrode; and a pump configured to move electrolyte between the metal electrode vessel and the at least one other electrode. Example 2. The system of example 1, wherein the at least one other electrode comprises: an oxygen reduction reaction (ORR) electrode; and an oxygen evolution reaction (OER) electrode, wherein the pump is configured to move electrolyte between the metal electrode vessel, the ORR electrode, and the OER electrode. Example 3. The system of example 2, wherein the ORR electrode comprises a plate structure, a shell and tube structure, or a spiral wound structure. Example 4. The system of example 2, wherein the ORR electrode is supplied with an oxygenated electrolyte stream, a mixed air and electrolyte stream, or separate air and electrolyte streams. Example 5. The system of example 2, wherein the OER electrode is a vertical OER electrode or a horizontal OER electrode. Example 6. The system of any of examples 1-5, wherein the electrolyte is concentrated hydroxide electrolyte. Example 7. The system of any of examples 1-6, wherein the metal electrode is an iron electrode. Example 8. The system of example 7, wherein the at least one other electrode comprises manganese. Example 9. The system of example 8, wherein at least one other electrode comprises manganese dioxide, carbon, and a polymer binder. Example 10. The system of example 7, wherein at least one other electrode comprises nickel. Example 11. The system of example 10, wherein at least one other electrode comprises nickel, carbon, and a polymer binder. Example 12. The system of example 7, wherein the iron electrode comprises direct reduced iron (DRI). Example 13. The system of example 7, wherein the iron electrode comprises packed or sintered iron powder. Example 14. The system of example 13, wherein the iron powder is sponge iron powder or atomized iron powder. Example 15. The system of example 7, wherein the iron electrode comprises: sponge iron powder and a polymer binder; or atomized iron powder and a polymer binder. Example 16. The system of example 15, wherein the iron electrode is formed without carbon. Example 17. The system of example 15, wherein the iron electrode further comprises carbon. Example 18. An iron-air flow battery, comprising: a fully open reactor through which iron materials and air are flowed. Example 19. The iron-air flow battery of example 18, wherein the iron materials comprise direct reduced iron (DRI). Example 20. The iron-air flow battery of example 18, wherein the iron materials comprise packed or sintered iron powder. Example 21. The iron-air flow battery of example 20, wherein the iron powder is sponge iron powder or atomized iron powder. Example 22. The iron-air flow battery of example 18, wherein the iron materials comprise: sponge iron powder and a polymer binder; or atomized iron powder and a polymer binder. Example 23. The iron-air flow battery of example 22, wherein the iron materials are do not include carbon. Example 24. The iron-air flow battery of example 22, wherein the iron materials further comprise carbon. Example 25. A metal/air energy storage system, comprising: a metal flow passage; metal pellets; one or more air electrodes; and one or more separators configured to separate the metal flow passage from the one or more air electrodes, wherein the system is configured such that the metal pellets are flowed through the metal flow passage past the one or more air electrodes. Example 26. The system of example 25, wherein the metal pellets comprise direct reduced iron (DRI). Example 27. The system of example 25, further comprising one or more electrolyte flow passages, wherein the system is configured such that the one or more electrolyte flow passages flow electrolyte between the metal pellets and the one or more air electrodes. Example 28. A bulk energy storage system, comprising: one or more systems and/or batteries of any of examples 1-27. Example 29. A long duration energy storage system configured to hold an electrical charge for at least 24 hours, the system comprising one or more systems and/or batteries of any of examples 1-27.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. An energy storage system comprising:
a metal flow passage;
metal pellets;
one or more air electrodes; and
one or more separators separating the metal flow passage from the one or more air electrodes,
the metal pellets flowable through the metal flow passage past the one or more air electrodes.

2. The system of claim 1, wherein the metal pellets include iron.

3. The system of claim 1, wherein the iron includes direct reduced iron (DRI).

4. The system of claim 1, wherein the metal pellets are porous.

5. The system of claim 1, further comprising one or more electrolyte flow passages.

6. The system of claim 5, wherein an electrolyte is flowable between the metal pellets and the one or more air electrodes via the one or more electrolyte flow passages.

7. The system of claim 1, wherein the one or more air electrodes includes a bifunctional electrode.

8. The system of claim 1, wherein the one or more air electrodes includes an oxygen reduction reaction (ORR) electrode and an oxygen evolution reaction (OER) electrode.

9. The system of claim 1, wherein the one or more air electrodes are electrically isolated from the metal pellets as the metal pellets flow through the metal flow passage.

10. The system of claim 9, wherein the one or more separators include a porous insulating layer.
